(19) United States
(12) Patent Application Publication
(10) Pub. No.: US 2026/0323685 A1
(43) Pub. Date: Oct. 15, 2026

(54) METHOD AND APPARATUS FOR DECENTRALIZED SLOT ACQUISITION AND PINNING IN WIRELESS MESH NETWORKS

(71) Applicant: goTenna Inc., Jersey City, NJ (US)

(72) Inventors: Subramanian Ramanathan, Westford, MA (US); Dmitrii Dugaev, New York, NY (US); Christophe Servaes, Guttenberg, NJ (US)

(73) Assignee: goTenna Inc., Jersey City, NJ (US)

(21) Appl. No.: 19/483,783

(22) PCT Filed: May 18, 2023
(86) PCT No.: PCT/US2023/022708

§ 371 Date: Nov. 12, 2025

(51) Int. Cl. H04W 74/02; H04W 74/00; H04W 84/18

(52) U.S. Cl. CPC H04W 74/02; H04W 74/002; H04W 84/18

(57) ABSTRACT

Slot pinning is provided in an improved Media Access Control protocol suited for low-capacity, mobile, decentralized mesh networks in which contention-based and contention-free access modes are utilized to obtain transmission rights initially and when reservations are not available.

### CROSS REFERENCE TO RELATED APPLICATIONS

This utility patent application claims priority to international patent application number PCT/US2023/022708 filed in the United States Patent and Trademark Office (“USPTO”) as the Receiving Office on May 18, 2023, which is incorporated by reference thereto in its entirety.

### BACKGROUND OF THE DISCLOSURE

Medium Access Control (“MAC”) is a known part of cellular networks and wireless network protocols (“WiFi”) that dominate untethered Internet access modalities. However, MAC for cellular and WiFi networks are centralized in that they exploit the availability of a base station or central hub of some kind to coordinate access between users. In a mesh network, there is no central entity, and therefore none of the techniques used for cellular or WiFi can be used. A decentralized solution is needed in the industry.

There are three broad categories of relevant MAC approaches in decentralized settings: Random Access Protocols—includes ALOHA and Slotted ALOHA and their variants. In (pure) ALOHA, nodes simply transmit when there is a packet to send. In Slotted ALOHA, nodes synchronize their slot boundaries, and transmit within the slots. While simple in operation, ALOHA is inefficient. There has been some research on Slotted ALOHA which increases the efficiency at the expense of requiring slot synchronization which is hard to achieve and is burdensome in a mesh network; Carrier Sensing Protocols—include the Carrier Sense Multiple Access (CSMA) with or without Collision Avoidance (CA). IEEE 802.11 DCF (based on CSMA/CA) has become the de-facto standard reference for the research and development of MAC protocols. However, this protocol was designed and engineered for WLANs. CSMA suffers from hidden node problems; and Scheduled Access Protocols—also referred to as Time Division Multiple Access (TDMA), this approach divides the channel to allow contention-free transmission. However, most scheduled access approaches thus far require transmitting the scheduling information, tight clock synchronization, and poor performance in bursty traffic. This is impractical and imposes unrealistic demands that slow adoption.

“Sync-less” on-demand TDMA protocols in the context of Mobile Ad Hoc Networks have been investigated including SITA (Sync-less Impromptu Time-divided Access), which is a unicast MAC protocol that uses CSMA and an initial handshake to obtain access rights, and employs a variant of pinning. However, SITA does not support broadcast transmissions and requires a handshake that increases overhead substantially.

What is needed in the industry are methods and systems for providing fully distributed MAC functionality in a wireless mesh network.

### BRIEF SUMMARY OF THE DISCLOSURE

The present disclosure is directed in general to fully distributed MAC functionality in a wireless mesh network. Since a wireless mesh network does not have centralized control elements, the disclosure provides the requisite functionality in a fully distributed manner—that is, all nodes execute a pre-specified (distributed) algorithm that involves coordinating with other nodes, sensing other nodes' transmissions, and delaying its own packets when needed to avoid collisions or conflicts. More specifically, described herein is a MAC protocol that is simple, fully decentralized, supports broadcast (one to many), supports unicast (1 to 1), adapts to the changing connectivity between nodes due to mobility, supports short-burst traffic, and uses very low control overhead.

In one embodiment according to the disclosure, a method of using a slot pinning protocol in a wireless mesh network, comprising accessing a mesh network having a plurality of sender nodes in communication therewith; sensing a packet to be sent from one of the sender nodes in the mesh network; identifying a target channel in the mesh network for sending the packet therethrough; employing a hybrid access protocol to obtain transmission rights on the target channel; determining by the hybrid access protocol that transmission rights are immediately available on the target channel at a time t, or determining that transmission rights are not immediately available, acquiring rights to the channel at a future time t_{f}, and pinning the acquired channel thereafter at a future time t_{f}. transmitting the packet on the target channel at the time t, or at the future time tr when the transmission rights become available on the pinned target channel.

According to the exemplary method, the mesh network may include low-capacity, mobile, or decentralized features, and the plurality of sender nodes may be in mutual communication to sense transmissions from each other on the target channel. The sender nodes may each employ an algorithm to delay sending a respective packet from a respective sender node to avoid a transmission conflict with another packet on the target channel.

In this aspect, the hybrid access protocol may initially employ a contention-based access protocol to obtain the transmission rights then utilizes a contention-free access protocol. By way of example, the hybrid access protocol obtains the target channel at the time t_{f}. More specifically, exclusive rights to the target channel are obtained by the hybrid access protocol at time t+nP, wherein n is a positive integer and P is a configured SPIN_PERIOD, until revoked.

According to this aspect, the hybrid access protocol supports broadcast and unicast conditions, and the hybrid access protocol is adaptable to fluctuating connectivity between at least two of the sender nodes, wherein the fluctuating connectivity may result from at least one of a sender node mobility, RF propagation issues, or channel noise.

Also in this aspect, the method may further include a complex packet occupying a chunk of slots in a Spin Cycle in which real time corresponds to cycle time in the Spin Cycle.

According to another embodiment of the disclosure, a slot pinning protocol in a wireless mesh network may include a hybrid access protocol configured to acquire a transmission channel in a mesh network by contention to create a chunk reservation for transmitting a packet on the transmission channel at a predetermined future time; and a Do-Not-Pin feedback feature configured for recognizing and communicating faults to the hybrid access protocol; wherein the hybrid access protocol utilizes the Do-Not-Pin feedback mechanism and a jittered transmission to reduce conflicts on the transmission channel.

The Do-Not-Pin feedback feature of the slot pinning protocol may be configured to diagnose the faults as one of a collision of multiple packets on the transmission channel, a reservation violation, or an overlap in time at the receiver between two or more transmissions, each on a different channel in the mesh network. Further, the jittered transmission may employ a random offset at a beginning of the chunk, the packet may fit into a single chunk on the transmission channel, and the hybrid access protocol may be further configured to obtain or reserve at least two consecutive chunks to carry a packet larger than a single chunk.

According to another embodiment, a method of aligning global chunks in a wireless mesh network using a slot pinning protocol may include receiving a chunk from one of a plurality of nodes; and checking refMaster for a start value wherein if the start value is larger than a largest node Id of the plurality of nodes, the refMaster is equalized to a source of a received/sent packet.

The method may also include rejecting the chunk or erasing prior chunks and aligning to the received chunk if the refMaster is not at an initial desired value, and further include lexicographically comparing a senderStatus=(received-pkt-source-id, received-pkt-seq-num) and myStatus=(refMasterId, refSeqNum).

According to the exemplary method, if myStatus is lexicographically greater than the senderStatus, no action is taken, but if myStatus is lexicographically less than or equal to senderStatus, the largest node deletes its chunks.

Additional objects and advantages of the present subject matter are set forth in, or will be apparent to, those of ordinary skill in the art from the description herein. Also, it should be further appreciated that modifications and variations to the specifically illustrated, referenced, and discussed features, processes, and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of the various embodiments, and others, upon review of the remainder of the specification.

### BRIEF DESCRIPTION OF THE DRAWINGS

A full and enabling disclosure of the present subject matter, including the best mode thereof directed to one of ordinary skill in the art, is set forth in the specification, which refers to the appended figures, wherein:

FIG. 1 is a flowchart showing an exemplary method of slot pinning;

FIG. 2 shows neighboring nodes and chunk reservation maps as employed in FIG. 1;

FIG. 3 is a diagrammatic representation of cycles at nodes corresponding to reservations as in FIG. 2; and

FIG. 4 is a flowchart showing additional steps in the exemplary method of slot pinning as in FIG. 1.

### DETAILED DESCRIPTION OF THE DISCLOSURE

As required, detailed embodiments are disclosed herein; however, the disclosed embodiments are merely examples and may be embodied in various forms. Therefore, specific structural and functional details disclosed herein are not to be interpreted as limiting, but merely as a basis for the claims and as a representative basis for teaching one skilled in the art to variously employ the exemplary embodiments of the present disclosure, as well as their equivalents.

Unless defined otherwise, all technical and scientific terms used herein have the same meaning as is commonly understood by one of ordinary skill in the art to which this disclosure belongs. In the event that there is a plurality of definitions for a term or acronym herein, those in this section prevail unless stated otherwise.

Carrier Sense Multiple Access (“CSMA”) as used herein means a contention-based access approach or mode.

Chunk as used herein means a slot or set of slots, i.e., reserved rights to a channel at a time t.

Chunk acquisition tolerance as used herein means a time budget that is inversely proportional to a node's backlog (queue length) for acquiring new chunks versus using existing chunks.

Do-Not-Pin (“DNOP”) feedback as used herein is a mechanism at a receiver for recognizing and communicating several types of faults, including collisions and reservation conflicts.

Global chunk alignment as used herein means aligning chunks without resort to clocks, GPS and the like, or to a centralized controller.

Hybrid access protocol as used herein means a contention-based and contention-free access mode used in Slot Pinning.

Jittered transmissions as used herein means using a randomly chosen offset from the start of a chunk to reduce collisions if two nodes access the same chunk.

Medium access control (“MAC”) protocols as used herein mean mechanisms that arbitrate access by a set of users (nodes) to a common (shared) channel.

Mesh network means a network of nodes in an interconnected topology that wirelessly communicate with each other to provide seamless wireless coverage over a relatively large area such as a city block or a neighborhood.

Nodes as used herein means a set of users.

Sync-less Impromptu Time-divided Access (“SITA”) as used herein means a unicast MAC protocol that uses CSMA and an initial handshake to obtain access rights and employs a variant of pinning.

Slot Pinning (“SPIN”) as used herein means the use of a mixture of contention-based and contention-free (also referred to as reserved or scheduled) access modes; i.e., SPIN uses contention-based access to obtain transmission rights initially and/or when reservations are not available, thus, SPIN accesses a channel in CSMA fashion and holds it in TDMA fashion.

Spin Cycle is a novel “frame” structure that is circular and can therefore allocate chunks anywhere. Again, the key idea is present in SITA (see above), but created and used differently.

Time Division Multiple Access (“TDMA”) as used herein means a protocol or mode for dividing a channel to allow contention-free transmission.

Wherever the phrase “for example,” “such as,” “including,” and the like are used herein, the phrase “and without limitation” is understood to follow unless explicitly stated otherwise. Similarly, “an example,” “exemplary,” and the like are understood to be non-limiting.

The term “substantially” allows for deviations from the descriptor that do not negatively impact the intended purpose. Descriptive terms are understood to be modified by the term “substantially” even if the word “substantially” is not explicitly recited.

The term “about” when used in connection with a numerical value refers to the actual given value, and to the approximation to such given value that would reasonably be inferred by one of ordinary skill in the art, including approximations due to the experimental and or measurement conditions for such given value.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, et cetera. Thus, for example, “a device having components a, b, and c” means that the device includes at least components a, b, and c. Similarly, the phrase: “a method involving steps a, b, and c” means that the method includes at least steps a, b, and c.

Where a list of alternative component terms is used, e.g., “a structure such as ‘a’, ‘b’, ‘c’, ‘d’ or the like,” or “a” or b,” such lists and alternative terms provide meaning and context for the sake of illustration, unless indicated otherwise. Also, relative terms such as “first,” “second,” “third,” “front,” and “rear” are intended to identify or distinguish one component or feature from another similar component or feature, unless indicated otherwise herein.

Unless the context clearly requires otherwise, throughout the description and the claims, the words “comprise,” “comprising,” and the like are to be construed in an inclusive sense as opposed to an exclusive or exhaustive sense; in the sense of “including, but not limited to.”

The various embodiments of the disclosure and/or equivalents falling within the scope of present disclosure overcome or ameliorate at least one of the disadvantages of the prior art or provide a useful alternative.

Detailed reference will now be made to the drawings in which examples embodying the present subject matter are shown. The detailed description uses numerical and letter designations to refer to features of the drawings. The drawings and detailed description provide a full and written description of the present subject matter, and of the manner and process of making and using various exemplary embodiments, so as to enable one skilled in the pertinent art to make and use them, as well as the best mode of carrying out the exemplary embodiments. The drawings are not necessarily to scale, and some features may be exaggerated to show details of particular components. Thus, the examples set forth in the drawings and detailed descriptions are provided by way of explanation only and are not meant as limitations of the disclosure. The present subject matter thus includes any modifications and variations of the following examples as come within the scope of the appended claims and their equivalents.

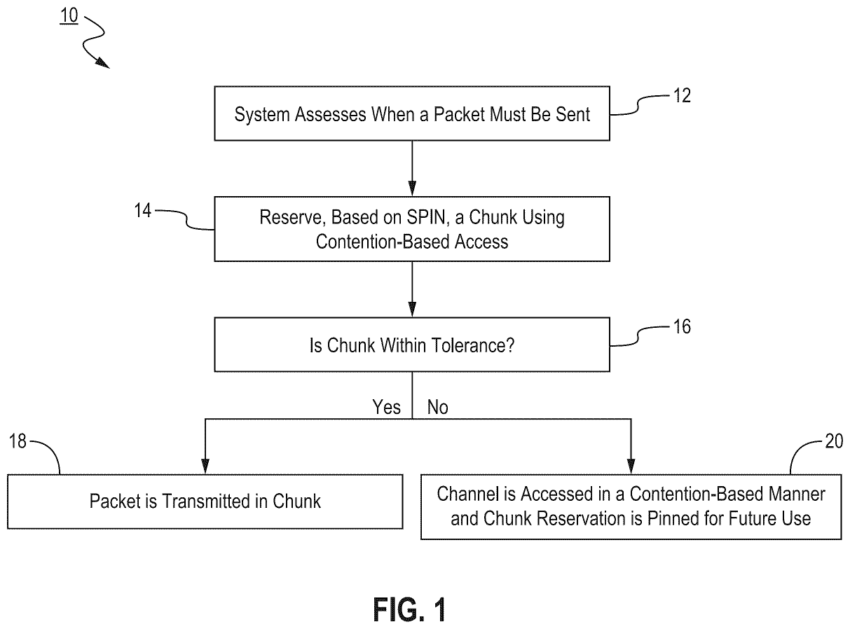

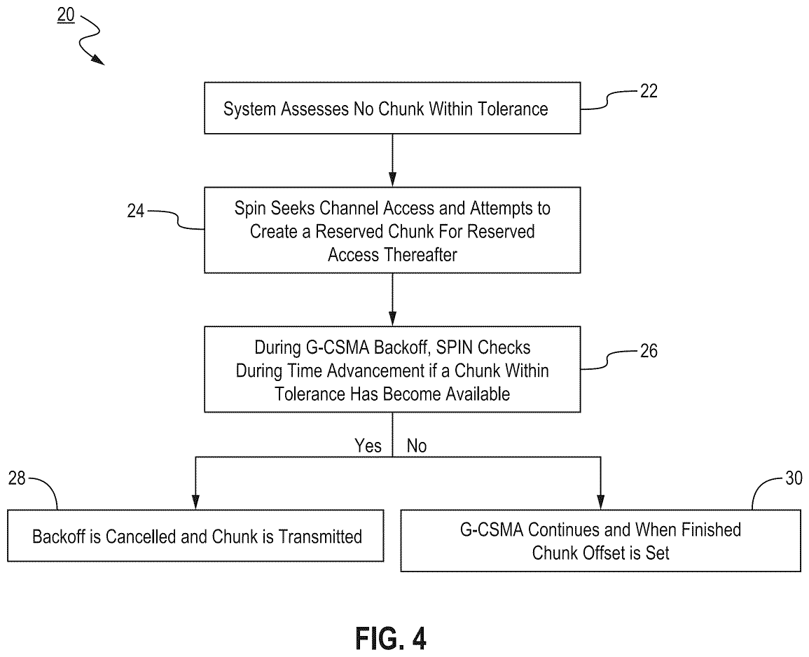

Turning now to FIG. 1, steps employed by a SPIN (Slot Pinning) protocol 10 show that when a packet needs to be sent at step 12, SPIN seeks a reserved channel or chunk at step 14 that it might have created for itself using a contention-based access mode. If such a chunk is found to be within tolerance at step 16 (which is related to the maximum delay the user/node is willing to accept per hop), it transmits in the chunk at step 18. If not within tolerance, SPIN accesses the target channel in a contention-based manner, and if successful, the chunk reservation is created or pinned for future use at step 20, which is discussed in greater detail with respect to FIG. 4 below.

The SPIN protocol 10 is, in some ways, a modified MAC protocol that builds upon Aspen Grove® G-CSMA protocols available from goTenna, Inc of New York. G-CSMA uses contention-based access, but SPIN more particularly uses a mixture of contention-based and contention-free (also referred to as reserved or scheduled) access modes. More particularly, SPIN uses contention-based access to obtain transmission rights initially and when reservations are not available. Upon successfully obtaining the channel at a time t, a node is granted exclusive rights to the channel at times t+nP, for n=1, 2, 3 . . . and where P is the configured SPIN_PERIOD, until revoked. The reserved slot (or set of slots), also called a chunk, is then referred to as being “pinned.” In other words, SPIN accesses the target channel in CSMA fashion and holds it in TDMA fashion.

SPIN is the only protocol that provides time-divided access with the following combination of features:
Decentralized with no central controller/hub or the election and use of a “master” node
No synchronization of time or slotting or framing across nodes; no use of GPS-based or other synchronization signals
Supports bursty traffic and mobility by re-adjusting schedules ad hoc
Supports reserved broadcast transmissions and unicast as truncated broadcast
Tolerant of hidden nodes in a broadcast setting unlike typical MAC protocols that only tolerate hidden nodes in unicast
Zero-control-packet-does not use explicit control packets to create/manage reservations

These features make SPIN an excellent fit for resilient, adaptive and efficient media access for broadcast traffic, especially in low-capacity mobile decentralized mesh networks. Further, SPIN currently assumes all transmissions are broadcast, that is, intended for all neighboring nodes.

Apart from the usual transmit/receive chains, there are four key modular components in SPIN that, if implemented properly, allow a change in operation of one component without affecting others:
Reservation creation and maintenance—this accesses a channel in a contention-based manner, and if successful, creates a chunk reservation for future use (“pins” a chunk).
Do-Not-Pin (DNOP) feedback—this mechanism at a receiver is for recognizing and communicating several types of faults, including collisions and reservation conflicts.
Transmit Procedure—this decides which chunk to use when sending a packet, and the process of selecting the slot within the chunk.
Receive Procedure is for packet reception and sending DNoP if necessary.
Global chunk alignment. A procedure that seeks to ensure that chunk boundaries are aligned across neighboring nodes, and by transitivity, across the network.

Referring again to FIG. 1, in order to de-conflict reservations on a chunk by multiple nodes, SPIN utilizes a fault recognition and feedback mechanism. A fault can be a collision on the same channel, an overlap on two different channels, or a reservation violation. When a receiver identifies a fault, it sends a burst of energy that is essentially a Do-Not-Pin indication (DNoP). A node receiving a DNoP on a prior reserved chunk either for transmitting or receiving immediately unpins the chunk and makes it available for future reservation. The use of an energy burst rather than any specific information implies that the collision of two DNoPs is a DNOP semantically. Thus, this approach robustly conveys the fault to all neighbors including the sender.

A node can have multiple reservations within the SPIN-PERIOD. SPIN adapts the number of reservations at a node to the extent of traffic demand at that node. Specifically, SPIN seeks a reservation within a time that is inversely proportional to the queue length, reserving using contention-based access if one such is not available. Thus, nodes with high traffic (e.g. critical nodes) will get more reservations than others.

Under high, bursty, and non-uniform loads, the chunk requirement of individual nodes can vary considerably. In order to avoid an elaborate decentralized reallocation scheme, SPIN allows a node to “borrow” neighbors' chunks if needed. Chunks expire after a configured period of non-use, both on the sender and receiver side.

SPIN allows transmissions to be packed much more tightly in time when compared to CSMA and avoids hidden terminal collisions via DNoPs, thereby increasing the effective capacity of the network.

SPIN is highly suitable for fixed length packets such as Position Location Information (PLI), with a chunk designed to fit such packets tightly. However, SPIN also allows longer packets by using two consecutive chunks to carry the packet. For still larger packets, CSMA can be used without reservation.

SPIN is further designed to be agnostic to the physical layer. It assumes a standard send/receive interface to the PHY layer. Additionally, it requires the ability to detect collisions and overlaps (if multi-channel) and the ability to generate a sinusoidal tone for the DNoP. SPIN is currently implemented on top of goTenna hardware but is portable in principle to other hardware.

To further understand SPIN, some concepts and components briefly introduced above as well as others and configuration parameters and their default values are described hereinafter.

### Concepts

Configuration Parameters and Defaults referred to herein are listed in the Table below.

| | Default | |
|---|---|---|
| Config Parameter | Value | Description |
| SLOT_DURATION_MS | 2 | Duration of a slot in millisecond. Not a SPIN- |
| | | specific parameter, but included here for |
| | | convenience |
| CSMA_IFS_SLOTS(hiP, | (18, 36) | The number of IFS slots for high- and low-access- |
| lowP) | | priority respectively |
| CSMA_BW_SLOTS(hiP, | (269, 419) | The number of backoff slots in the window for |
| lowP) | | high- and low-access priority respectively |
| CSMA_FORCED_BKOFF_WIN | (31, 41) | The forced backoff is picked randomly between the |
| (start, end) | | (start, end). |
| SPIN_PERIOD_SLOTS | 6000 | Number of slots in the Spin Cycle |
| SPIN_CSMA_ONLY_MODE | 0 | If set to 1, SPIN will work like G-CSMA, won't |
| | | pin any chunks |
| SPIN_TOLERANCE_SLOTS | 600 | Base or maximum tolerance value. |
| SPIN_CHUNK_EXPIRY_SECS | 180 | Chunks expire after this amount of unused time |
| ABORT_TIMEOUT_SECS | 3.9 | If more than this many seconds have elapsed since |
| | | the packet was received AT the network layer, the |
| | | pkt is discarded |
| SPIN_NUM_RESV_JTR_SLOTS | 2 | Number of possible start slots for a reserved |
| | | transmission |
| SPIN_NUM_UNRSV_JTR_SLOTS | 3 | Number of possible start slots for a |
| | | virtual/borrowed transmission |
| SPIN_GLOBAL_ALIGN_RESET_MINS | 10 | The Spin Cycle is completely erased with this |
| | | period. |

Time is divided into slots (of duration SLOT-DURATION). The slots are purely local and are not synchronized across nodes with respect to a “global” time such as GPS. A MAC packet is sent over a set of slots known as a chunk. The number of slots in a chunk depends on the size of the packet, and additional slots to accommodate deliberate jitter and clock drift. A chunk covers both control and data packet transmission, that is, within a chunk the sender sends the sync frame and then switches to the data channel to send the data frame. All references to time will be based on the slot number starting from activation, that is, a slot is the basic unit of time.

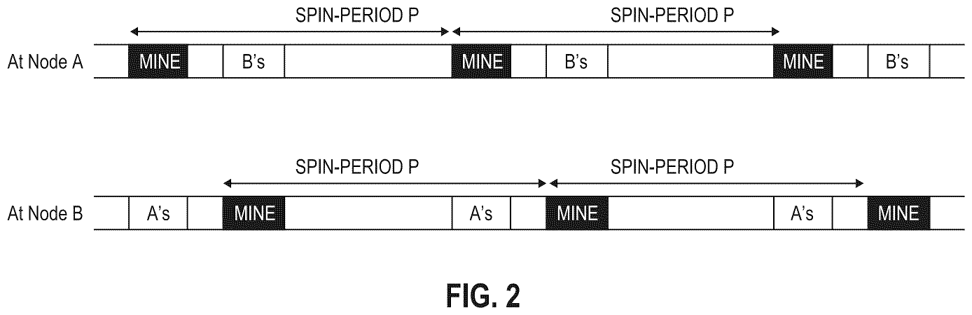

As introduced above, when a node sends a packet over an unreserved chunk (s, e), where s is the start time of the chunk, and e is the end time, and is deemed successful (no DNoP), it acquires transmission rights for intervals (s+P, e+P), (s+2P, e+2P), (s+3P, e+3P) and so on. Other nodes “mark” these chunks and desist from transmitting in these chunks, and may have their own chunk reservations. An example of two neighbor nodes A, B and their chunk reservation maps are shown in FIG. 2. More specifically, nodes in FIG. 2 mark their chunk reservations and others' reservations. Here, propagation delay is assumed to be zero, and the nodes seek to transmit on their chunks and avoid transmitting on others' chunks.

There is no explicit synchronization between the chunks in FIG. 2, i.e., there is no common reference time between A and B. B reserves A's chunk based on when the corresponding packet arrives and P, P+2P . . . slots thereafter. The reservation at the sender is with respect to the sender's local time, and the reservation at the receiver(s) is with respect to their local times. In other words, SPIN has relative synchronization, rather than absolute synchronization. This automatically accounts for any amount of propagation delay, as long as it is the same over time, and clock drift is manageable.

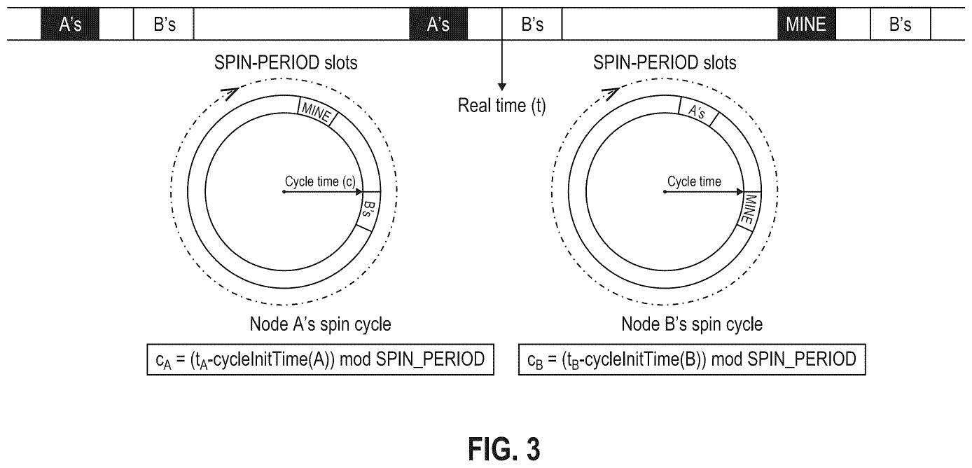

As it is extremely difficult to track every reservation explicitly in the time domain, a circular representation termed a Spin Cycle that captures all the reservations is shown in FIG. 3. The Spin Cycle contains SPIN-PERIOD slots. A packet occupies a chunk of slots. As time advances at a node, a virtual pointer rotates in the Spin Cycle. Every real time (e.g. microseconds elapsed since node activation) can be mapped into the corresponding cycle time (slot number) using modulo-arithmetic on the SPIN-PERIOD and the (re)-activation time of the cycle. This is analogous to a clock which cycles around periodically (12 hours), and where every real time can be converted into a clock time.

More particularly, FIG. 3 shows the Spin Cycle for node A and B for the reservations. At real time t, node B is ready to transmit at its reserved chunk. The real time is converted into a cycle time c using the formula shown, which points to corresponding reservation in the cycle. Every SPIN-PERIOD slots, the cycle time will point to the same position with Node B transmitting and Node A receiving.

FIG. 3 further shows cycle times of Node A and B to be in sync for simplicity. In other words, the cycle initialization time is assumed to be the same for both, and the clocks are assumed to be in sync. However, even if the cycle initialization time and clocks are different, and the cycle time pointers point differently, the scheme will work as long as both use the same cycle period (SPIN-PERIOD) and clock drift is negligible. In the clock analogy, this is like person A calling person B in a different time zone every day at the same time (A's time). Clearly, B will get the call at the same (B's) clock time each time. Thus, with the Spin Cycle, a list of the reserved and reservable chunks within a SPIN-PERIOD can simply be tracked, but the Spin Cycle preferably should be implemented as a separate module with methods for management.

### Structures.

### Header Extension

SPIN adds three fields to the MAC header, specifically, using the “Reserved” byte.
Reserve-request/refresh (1 bit)—when the reserve-request/refresh bit is set, it indicates from the sender to the receivers that a reservation is requested on the corresponding chunk, or if the corresponding chunk is already reserved, it serves as a refresh of the reservation. The reserve-request bit is set based on packet type, user policy, queue length and any other directive from the network layer or configuration. For example, it could be un-set for long packets and packets from sporadic flows.
CSMA mode (1 bit)—this is set to 1 if the transmission used the G-CSMA process, and 0 if the transmission did not. The latter is when SPIN has a reserved owned chunk available and transmits on it.
Chunk-offset (k bits)—this indicates the number of slots by which the sender jitters its transmission within a chunk. The receiver uses this to compute the start and end slots of the sender's chunk. k=ceiling (logbase2 (SPIN_NUM_RESV_JTR_SLOTS)). With the current default being k=2 bits.

### Chunk Components

A chunk is a group of slots that is designed to hold a packet and associated parameters. It consists of the following space allocations in which the location of some of these fields will vary depending on the packet length and jitter and therefore should be regarded more as an allocation of “space” rather than rigid positions.
Prefix (1 slot)—this is a margin to allow for drift that causes packets to arrive earlier than initially.
Jitter (currently 3 additional slots)—the packet can start right after the prefix (1st slot after) up to Jitter slots after the prefix.
Padding (2 slots)—these are needed to enable proper carrier sensing in the jitter slot.
Packet (currently max 43 slots)—this includes both the control and data frames. Note that the packet may be sent across multiple channels. An exemplary frame format may have a maximum size for a packet fitting in 1 Ctrl frame+gap+1 Data frame is: 31.25 milliseconds (ms)+3 ms+51.25 ms=85.5 ms. At 2 ms per slot, this is 43 slots
Gap (2 slots)—this is time that allows a receiver to detect overlaps.
DNOP (2 slots)—Time allocated to send a DNoP; for example, sending a DNoP in the last two slots before the suffix when possible.
Suffix (1 slot)—this is a margin to allow for drift that causes packets to arrive later than initially.

Each node allocates a chunk with a number of slots equal to the sum of the above, which is denoted by chunk-length. For example, a chunk-length may be 54 slots, assuming that packets fit within a single chunk.

### Spin Cycle

The Spin Cycle contains a list of chunks, including reserved (or “pinned”) and un-reserved (or “un-pinned”) chunks. Each chunk in the Spin Cycle has information associated with it to support the protocol operation. The particular information stored with the chunk can vary depending on the implementation, but some example fields are as follows.
isReserved—means whether the chunk is reserved or not. It is set to 1 when the chunk is reserved either by this node or a neighbor and set to 0, when “freed”, e.g. upon expiration.
Start-slot—the first slot number of the chunk
End-slot—the last slot number of the chunk
Owner—if this chunk is created by the transmitter, then own id, else the id of the nbr who owns it.
Last-used-at—current clock time, will be updated each time it is used, to facilitate expiry.

The number of chunks (NUM_CHUNKS) in the Spin Cycle is the SPIN_PERIOD divided by the chunk length in slots. The SPIN_PERIOD should be set to be an integral multiple of the chunk length, or adjusted at run time to be the closest integral multiple to the set value. Thus, in an exemplar implementation, the Spin Cycle is essentially an array of chunks indexed from 0 to NUM_CHUNKS−1. As a consequence, the start-slot and end-slot of a given chunk are fixed and can automatically be derived from its chunk number. Specifically, the start and ends slots of chunk i are start-slot (i)=i*chunk-length, and end-slot (i)=start-slot (i)+chunk-length−1. Maintaining the start-slot and end-slot as part of the chunk fields is most convenient.

The Spin Cycle is initialized upon the receipt of the first packet, to start with the first slot of the chunk to be “time 0”. The real time corresponding to this is referred to as the initializationTime, and used in the conversion from time-to-slot and slot-to-time.

### Chunk Expiration

Chunks that are unused for a configured period of CHUNK_EXPIRY_SECS seconds based on the last-used-at field of the chunk are deleted from the Spin Cycle. A check is performed for expired chunks as frequently as is practical, but no less frequently than every cycle. Borrowing a chunk, that is, using a chunk that does not belong to the sender, does not refresh its usage.

The above procedure occurs both at the sending side and the receiving side. This happens independently with independent timers. Thus, there could be small periods when one node may have a chunk and a neighbor may not.

### Transmit Operation

The functionality described in this section relates to when a packet is received from the NET layer for transmission. Along with the packet, three “meta-data” items are passed down:
Access priority (MD_accessPrio): Determines the backoff slot selection for CSMA access
Current NET queue length (MD_queueLen): Used to determine chunk selection tolerance
Arrival time at NET layer (MD_arriveTime): Used to determine packet expiry
   First, a MAC layer header is attached. This header includes the basic MAC layer header plus the header extension described. In the extension header, SPIN sets the reserve-request bit to 0 if SPIN is configured to operate in G-CSMA mode (configuration parameter SPIN_CSMA_ONLY_MODE is 1), otherwise, it is set to 1. The CSMA-mode and Chunk-offset will be initialized later. SPIN then initiates the access procedure, as provided below.

### Access Procedure Overview

The Access Procedure is the way by which a packet at a given node contends for access to the channel before transmitting. Only one packet may be in the Access Procedure from a given node at a given time.

Each time the access procedure is invoked, if the current time is greater than MD_arriveTime+ABORT_TIMEOUT_SECS, the packet is discarded and the access is aborted. This is to account for the rare cases when the packet is significantly delayed to be no longer useful. An indication is sent to the network layer so that any required action can be taken (e.g., in ECHO, the IA is canceled for the packet). Otherwise, the procedure continues as below.

If SPIN is configured to operate in G-CSMA mode (configuration parameter SPIN_CSMA_ONLY_MODE is 1), then the G-CSMA protocol is invoked, as specified herein. Note that since reserve-request is set to 0, this will not seek or get a reservation.

The Access Procedure seeks a reserved owned chunk within a certain number of slots, namely the tolerance, from the slot corresponding to the current time. The method for computing tolerance is provided in “Computing Tolerance” below. If not found, it invokes the Reservation Creation/Borrowing Procedure. The Access Procedure may be invoked multiple times during the processing of the packet, once initially, and whenever a packet is deferred due to a chunk being busy. Each time it is re-invoked, the relevant header fields and metadata must be properly updated.

If there is at least one reservation in the Spin Cycle within tolerance (obtained through the mechanism that will be described herein), then “spin mode” is in effect. SPIN schedules the transmission of the packet for the start of the earliest such chunk and transmits it using the chunk access procedure.

### Computing Tolerance

The value of tolerance is adaptive to the queue length at the NET layer after dequeuing this packet (which is passed down as metadata MD_queueLen), and is computed as follows:
tolerance=min(tolerance-budget, computed-tolerance)
where computed-tolerance=max(qLenBasedTolerance, chunk-length+1)
where qLenBasedTolerance=SPIN_TOLERANCE_SLOTS/max((MD_queueLen+1), 1)
where SPIN_TOLERANCE_SLOTS is a base tolerance when the queue has 0 or 1 packets. As the queue length increases, the tolerance decreases as given by the above formula. Thus, as the load on the node increases, SPIN seeks to clear it out by seeking progressively sooner transmission opportunities. Specifically, the above formula seeks to limit the delay of every packet to SPIN_TOLERANCE_SLOTS no matter its location in the queue, subject to a “floor” of chunk-length+1.

The tolerance-budget is relevant when the access procedure is re-invoked, say due to the channel being busy at the time of transmission; in this case, since some time has already elapsed, the calling module provides a value that overrides the computed-tolerance as above. In order to facilitate computing the tolerance-budget, the current tolerance end (tolerance-deadline) should be tracked, possibly as metadata for the packet. The computation of tolerance-budget is addressed elsewhere herein. Note that the tolerance-deadline is distinct from the absolute deadline based on the SPIN_MAX_HOLD_SECS discussed above.

The use of tolerance supports bursty, heterogeneous traffic-if one node has lots of packets and neighboring nodes have few, the high-traffic node will acquire more reserved chunks and drain its queue.

### Carrier Sense Multiple Access (G-CSMA)

If the packet originated at this node, the node waits for a time called the Inter-Frame Spacing (IFS_SLOTS) corresponding to its access priority passed down from the network layer as metadata (MD_accessPrio). The mapping between the access priority and the IFS_SLOTS is configured (CSMA_IFS_SLOTS). If the channel is sensed to be free (see below) within the IFS period, the packet is transmitted immediately after the expiration of the IFS spacing. If not, the node enters into backoff as described below and see FIG. 4.

If the packet was not originated at this node, the node waits for an IFS corresponding to the packet priority and then directly enters into backoff as described below. That is, it is prohibited from sending even if the channel is free for the duration of the IFS. When the backoff ends, it checks whether it needs to backoff further for fairness purposes—i.e., do a forced backoff as described below.

When a node acquires access to transmit, it transmits the packet in its entirety in one shot, that is, it transmits the control frame, data frames (1-3) without having to re-contend for access between frames. Thus, the procedures below pertain to the packet as a whole.

### Channel Sensing

In order to decide whether a given channel is free or busy in a given slot, a node uses the energy detect functionality. Specifically, it receives the RSSI (Received Signal Strength Indication) from the Physical Layer in that slot (rssi_dBm). Based on past receptions, it also keeps track of the average noise level (rssiNoise_dBm). The channel is deemed to be busy if either the absolute value of rssi_dBm exceeds a given threshold (currently −70 dB) or exceeds the noise floor by a given value (currently 30 dB).

More precisely, the current criteria to mark a channel busy is:

(rssi_dBm>(rssiNoise_dBm+30 dB)) OR (rssi_dBm>−70 dBm)

where
the rssi_dBm is the current measurement
the rssiNoise_dBm is our running average of rssi (ie, the noise)
   Note: the use of a noise threshold is helpful in noisy environments.

### Random Backoff

In the random backoff procedure, a node picks a random slot number between the current slot and a backoff window, i.e., a randomized offset between (0, min(tolerance, CSMA_BW_SLOTS)), where tolerance is the current tolerance as computed above. CSMA_BW_SLOTS is parameterized based on access priority.

Let b be the number of slots picked using the random generation above. Then, as each slot passes, the node decrements b if the channel was sensed free during that slot, else not. That is, as long as the channel is busy, the counter b is “frozen”. When b is zero, the packet is transmitted.

The random backoff procedure has the property that nodes that pick numbers in a certain order preserve that order when the channel transitions between busy and idle.

### Forced Backoff

After a node finishes a transmission, it goes into a mandatory forced backoff of fixed duration. This is to prevent a single node from monopolizing the channel. The forced backoff is simply a random duration where the node cannot transmit. The random duration is picked within a configured and is using a configurable parameter window controlled CSMA_FORCED_BKOFF_WIN. A random forced backoff value is picked with an offset between (CSMA_FORCED_BKOFF_WIN.start and CSMA_FORCED_BKOFF_WIN.end).

### Reservation Creation/Borrowing Procedure

The step 20 introduced in FIG. 1 above is shown in more detail in FIG. 4. Here, when there is no chunk within tolerance as indicated at step 22, SPIN seeks access to the channel and possibly creates a reserved chunk for reserved access thereafter at step 24 by initiating the G-CSMA protocol, as provided herein, with one key exception: during the backoff in G-CSMA, SPIN checks if the advancement of time has resulted in a chunk being available within tolerance at step 26. If at any point a new chunk becomes available within tolerance, it cancels the backoff and goes into “spin mode” wherein it schedules a transmission for that chunk and invokes the procedure to transmit on that chunk at step 28. If not, it continues with the G-CSMA and when the G-CSMA finishes, SPIN is ready to transmit the packet. Before transmitting, it sets the CSMA-mode field in the packet header to 1, and sets at step 30 the Chunk-offset field in the packet header to indicate the offset from the start of the chunk it plans to reserve (see next paragraph), so that the receiver can use that information to reserve the corresponding chunk at its end. Specifically, it computes the Enclosure of the transmission start slot, say S. This returns a chunk, say C. Then the Chunk-offset is set equal to slotSubtract(S, C.startSlot). The setting of Chunk-offset is optional if the reserve-request/refresh bit is 0.

After transmitting, SPIN proceeds to reserve a chunk, if appropriate. It first checks if the reserve-request/refresh bit is set. If it is not, then it exits the procedure since no reservation is requested. Otherwise, it reserves the chunk in which the transmission started, as follows: it first computes the Enclosure of the transmit start slot. The Enclosure procedure is described herein, and returns the chunk within which the transmission time lies. There are three possibilities:
The chunk is unreserved, i.e., the isReserved field is 0. In this case, SPIN marks the chunk reserved and assigns self (the node on which this procedure is executing) as the owner. It initializes the Last-used-at to the current time.
The chunk is reserved, and the owner is not self. In this case, no updates are made. The transmission ended up “borrowing” a neighbor's chunk, which is acceptable, but the neighbor retains ownership.
The chunk is reserved, and the owner is self. This should not happen if the node is continually checking for chunk availability while backing off, but can happen if the check is occasional or at the end. In this case, again no updates are done.

### Transmission on a Reserved Chunk

This procedure is invoked when a node is ready to transmit on an owned reserved chunk. This procedure can be entered if SPIN finds an own reserved chunk within tolerance at the start of the access procedure, or if it doesn't find one at the start but finds one during the subsequent G-CSMA procedure. At this point the chunk to be transmitted on has already been selected. The following procedure determines when in that chunk the transmission happens.

SPIN employs a concept termed herein as “Sense-Aloha,” which is a combination of carrier sensing and the ALOHA protocol. The idea is to jitter the transmission within a larger chunk window and defer if another node that is using the same chunk with a smaller jitter acquires the chunk first.

### Scheduling the Transmission

The transmission within the chunk is offset from the start of the chunk. The offset is a value randomly chosen within a window (Wₘᵢₙ, Wₘₐₓ), inclusive on both ends, that is, both Wₘᵢₙ and Wₘₐₓ are candidates for choice.
Wₘᵢₙ=0
Wₘₐₓ=SPIN_NUM_RSRVD_JTR_SLOTS−1

A random jitter value is picked within the window as
j=rand (Wₘᵢₙ, Wₘₐₓ), range inclusive on both ends.

For example, if SPIN_NUM_RSRVD_JTR_SLOTS is 4, then j is randomly chosen amongst 0, 1, 2, 3.

The transmission is scheduled to begin at (j+Prefix) slots from the start of the chunk. Further, this value (j+Prefix) is inserted into the SPIN header in the Chunk-offset field.

### Deferring Transmission

Before transmitting at the slot scheduled using the procedure described above, SPIN checks to determine if any of the control channels are busy (either the RSSI is greater than a threshold, or the node is receiving a packet). This could happen if another node picked the same chunk for transmission, but picked a lower random jitter j. If at least one of the control channels is busy, SPIN cancels the transmission and re-seeks a chunk within a revised tolerance budget computed as:

revised-tolerance-budget=max(r,(chunk-length+1))

where r is the residual tolerance at current time and is computed as

r=max(slots(d−t),T−1)

where t is the time at chunk start, d the tolerance-deadline, T=SPIN_TOLERANCE_SLOTS

Re-seeking a chunk is done by re-entering the Transmit Operation (see above) and restarting but now using the revised tolerance budget for its operation.

Note that occasionally a CSMA mode transmission might happen to fall within SPIN_NUM_RSRVD_JTR_SLOTS from the start of a chunk. In such a case, the CSMA transmission will preempt a legitimate reserved transmission. Since the latter is not lost but re-scheduled, and the situation is low probability, it is disregarded.

### Before Transmission

Before transmitting, SPIN sets the CSMA-mode field in the packet header to 0, and the Chunk-offset to the offset from the beginning of the chunk. Specifically, the Chunk-offset is set equal to slotSubtract (S, C.startSlot) where S is the slot at which the transmission begins, and Cis the chosen chunk. The setting of Chunk-offset is optional if the reserve-request/refresh bit is 0.

### After Transmission

If the packet is not deferred as described in the previous section, it is transmitted. After transmission, SPIN updates the chunk information fields as appropriate and waits to see if the receiver has sent a Do Not Pin (DNoP) signal. To check, it sets a DNoP-Timeout and tunes to the first control channel. If there is a DNOP received within the DNoP-Timeout, the chunk is relinquished, i.e., the isReserved bit is set to 0 and the owner to NULL. The DNoP-Timeout should be set to the end of the current chunk, plus at least 1 slot to account for any round-trip and processing delays. If there is no DNOP received, it proceeds as follows.

If the packet was sent using CSMA, SPIN reserves the chunk on which the packet was sent, unless the chunk is already reserved in which case no action is taken. Note that with CSMA, the node may transmit on a chunk owned by a neighbor since it transmits when the G-CSMA procedure ends. Specifically, it reserves the chunk enclosing the starting slot of the transmission, which may be computed using the Enclosure procedure. It sets the isReserved to 1, updates the owner field to the sending node id, and the Last-used-at field to the current time.

If the packet was not sent using CSMA, no action is taken on reservations since it is an owned chunk and can continue to remain so (since no DNOP was received).

If the packet was not sent using CSMA, SPIN continues to remain on the control channel it used to send the packet, awaiting a possible DNoP, but only until the end of the chunk. Otherwise, or after the chunk ends it goes into “idle” mode, sleeping and cycling through channels.

### Receive Operation

All successfully received packets are delivered to the Network Layer. This includes packets that may have experienced a collision but have been captured. The receive operation has two broad branches, one for packets received successfully, including those that collided but were captured, and one when a packet failed but a collision/overlap was detected. These procedures utilize Enclosure and DNOP procedures. Note that if a packet fails but no collision/overlap is detected, the receiver is unaware of any “event”, so it goes without saying that no action is taken. The detection of collision/overlap is hardware dependent.

Presumably the MAC is able to determine the start-time and end-time (in real clock time) for a transmitted or received packet. If, because of lack of PHY-layer visibility, only the end-time can be determined, the start-time can be computed as the end-time minus the packet duration. The packet duration can be inferred by a field in the header (e.g., RFIC in goTenna) length. The exact determination may be system dependent, but it is not crucial what method is used as long as the times are obtained.

SPIN then converts the (start-time, end-time) to (start-slot, end-slot) in the Spin Cycle. This can be done utilizing the timeToSlot primitive/macro described below and is used in both of the procedures below.

### Packet Success

If the packet is received successfully, SPIN proceeds to check for Global Alignment, reservation conflicts, or chunk reservation according to the following exemplary methods:
ALIGNMENT CHECK METHOD 1:
   SPIN first checks for alignment between the sender and receiver chunks. This check depends upon whether the packet was sent in CSMA mode or not, which is indicated by the CSMA bit in the header. If it was NOT sent in CSMA mode, then it can be inferred that the chunks are aligned as long as the start and end slots of the received transmission are enclosable in the same chunk. However, if it was sent in CSMA mode, this method will not work since the packet started from an arbitrary slot. In this case, SPIN uses the Chunk-offset field in the header, which is used by the sender to indicate the offset from the start slot at the sender. By subtracting the Chunk-offset from the received start slot, SPIN infers the start slot of the sender's chunk and then checks if the inferred start slot and end slot are enclosable. The Enclosure procedure is described below. Note that for the alignment check the optional end slot parameter is used. If the (start, end) are not enclosable in the same chunk, the global alignment procedure is triggered as discussed below.
ALIGNMENT CHECK METHOD 2:
   SPIN first checks for alignment between the sender and receiver chunks. To do this, SPIN infers the chunk start slot of the sender and compares it with the start slot of its own (the received node's) enclosing chunk. Specifically, suppose myChunkStartSlot refers to the receiver's slot in which the packet started, and the senderChunkStartSlot is the start slot of the chunk within which the packet transmission began. Recall that the header contains the jitter (offset) within the chunk. SPIN computes these values as follows:

senderChunkStartSlot=slotSubtract(rcvdPktStartSlot,header.jitter)

myChunkStartSlot=enclosingChunk(rcvdPktStartSlot).startSlot
If the difference between myChunkStartSlot and senderChunkStartSlot is a multiple of the chunk length in slots, it means that the Spin Cycles are aligned. Otherwise the global alignment procedure is triggered.
The global alignment procedure may deem either that the receiving node (“this” node) is dominant, or the sender is dominant. In the former case, no reservation processing is done, and the procedure terminates. In the latter case, the global alignment procedure re-initializes the Spin Cycle to be aligned with the sender. The procedure then terminates. Note that if the chunks are not aligned in the first place, the chunk is not reserved.
If it is deemed that the chunks are aligned, then SPIN processes the enclosing chunk, say C, for possible reservation or conflict thereof. Note that the computation of the start slot for the determination of C depends on whether the packet was sent in CSMA mode, as discussed above. There are two cases:
   If C.isReserved is 1, meaning it is already reserved, SPIN checks for conflicts, i.e., if reservation was requested (i.e., the reserve-request in the header is 1), and the sender of the packet is different from C.owner. If it is, and if the packet was NOT sent in CSMA mode (i.e, if the CSMA-mode in the header is 0), a DNOP is triggered. Otherwise, the chunk is refreshed by updating the C.lastUsedAt to the current time, and the procedure ends.
   If C.isReserved is 0, meaning the chunk is unreserved, SPIN reserves the chunk setting C.owner to the sender id, the C.isReserved to 1, and the Last-used-at field to the current time. Then the procedure ends.

### Packet Failure: Collision/Overlap Detected

If a packet fails, and collision/overlap is detected, the following steps are executed:
The Enclosure procedure is attempted as described above based on the start and end slot delineating the collision or of the packet. The former can be surmised by tracking the rise and fall in energy, and finding the start and end slots such that all of the energy is between those slots. The Enclosure procedure “maps” an incoming packet to a chunk, or returns an indication of failure—this could happen if the Spin Cycle is empty, or if the packet is attempted to be mapped to a chunk but the start-slot and end-slot fall in different chunks. The idea is to “infer” if the packets were sent on a reserved chunk or not by seeing where they fall.
If the collision/overlap/packet can be enclosed, a DNoP is sent in the DNOP slots of the chunk returned by the Enclosure procedure. Note that sometimes a DNoP may be sent even though the packets involved were sent in CSMA mode, that is, if the entirety of the packet transmission falls within the chunk boundary. This may result in inadvertent un-pinning of a chunk, but this is a low probability event.

The following various procedures introduced above, namely, the Enclosure, Do-Not-Pin procedure and the detectability constraints are now described in greater detail.

### Enclosure

The purpose of the Enclosure procedure is to determine the most appropriate chunk for either a packet (by giving the start and end slot of packet reception) or for a single slot. The Enclosure procedure returns the chunk, or an indication of failure to find one. Note that when called for a slot, it will always return a chunk.

Assuming the “array-like” indexable implementation of the Spin Cycle, finding the chunk enclosing a single given slot is a straightforward DIV operation as provided below in enclosingChunkIndexOfSlot.

To find the chunk, if there is one, enclosing a given start and end slot, the Enclosure procedure first finds the chunk indices of the two slots as in enclosingChunkIndexOfSlot below. If the two indices are equal, it means that the entire packet is enclosed within the same chunk, and that chunk is returned. If not, it means that the packet is not enclosable within a single chunk, and a failure indication is returned.

### Do-Not-Pin (DNOP) Procedure

This procedure is executed at the receiver of a packet and conveys to the sender that the chunk on which this packet was sent should not be pinned. If it is pinned, it should be unpinned.

Note that unlike in SPIN v1, DNoPs in this version are only sent after the pinning has happened. That is, a conflict is permitted to arise during the chunk acquisition procedure, but the conflict is detected during usage, and the chunk unreserved. It is possible that a chunk is owned by multiple nodes, but it is never recognized since they were “lucky enough” to not transmit simultaneously. In this case, the conflict is not resolved but is a nonissue.

A chunk on which a packet was sent may need to be un-pinned for the following reasons:
1. The packet experienced a collision on the same channel with another packet(s). It is possible that one or all of the packets is received successfully in spite of the collision due to capture properties of the receiver. Nonetheless, it is deemed unpinnable in the future since the capture may not happen subsequently.
2. The packet experienced an overlap with another packet(s) on a different channel. This causes either this packet or the other packet to be not received. It is possible that one of the packets is received successfully. Nonetheless, it is deemed unpinnable since one of the packets is lost.
3. The packet was successfully received, but there is an ownership conflict. That is, the chunk's owner field is different from the sender ID.

For both numbers 1 and 2 above, there could be two types of collisions/overlaps: a Rcv-Rcv collision/overlap where the node in question is receiving from two other nodes but not itself transmitting; or an Xmt-Rcv collision/overlap where the node in question itself is transmitting while receiving from another node. The ability of the receiver to detect these transmissions depends upon the receiver constraints and the detection mechanism implemented. For example, detection constraints and a mechanism for detection in goTenna firmware are described below.

For number 3 above and in the recovered case of numbers 1 or 2, a DNoP is only sent if the packet's CSMA-mode bit is 0, that is, the sender intends to send the packet on a chunk that is owned by the sender. Packets sent during the Reservation Creation/Borrowing Procedure are sent with CSMA-mode bit set to 1 and hence will not trigger a DNOP even if there is a collision/overlap/conflict. Further, no DNOP is sent if SPIN is configured to operate in G-CSMA mode (that is, if configuration parameter SPIN_CSMA_ONLY_MODE=1).

A DNOP is a “burst of energy” at the maximum power for the duration of two slots. The exact details of the burst of energy depends upon what is available in the radio, but could be for example, a sinusoidal tone, a preamble, a sequence of 1's etc. In one implementation utilizing an SI 4460 chip, a continuous wave (a sinusoidal wave) is employed. The main requirement is that it be detected at a receiver purely by means of “energy detect,” i.e., there is no need to acquire a preamble.

### Sending DNoP

The DNOP is sent in the “DNOP slots” of the enclosed chunk of the ending slot of the packet. That is, the slot corresponding to the receive end time is taken and the Enclosure procedure (see above) is performed on that slot. If the Enclosure procedure returns a valid chunk, then a DNoP is sent on the DNOP slots of the chunk, typically the last two slots in the chunk barring the suffix provided the current time is less than the DNOP sending time, else no DNOP is sent. If the Enclosure procedure returns NULL (this should only happen if there are no chunks, as in the initialization stage), no DNoP is sent.

Multiple receivers may send a DNoP. What if two DNOP's collide? Here is where the semantics of the DNoP plus the fact that “burst-of-energy”+“burst-of-energy”=“burst-of-energy” work in our favor—from the sender's viewpoint, it sees a DNoP and does not pin, which is exactly the behavior required.

If the node is busy with a receive at the appointed time of sending the DNoP, the transmission is simply aborted and the DNOP discarded. This may happen during the chunk acquisition phase if the CSMA ends on this chunk.

The DNoP is always sent on the FIRST control channel, that is the one with the lowest id (assuming there is an ordering of the channels by some means).

After sending a DNoP, the node that sent the DNoP also un-pins the corresponding chunk (the one on which it sent the DNoP). This is because it had it pinned before per previous logic, and since it has requested neighbors to un-pin the chunk, it makes sense to un-pin it itself. To unpin a chunk, SPIN sets its isReserved to 0, and resets other fields as well. The chunk is now free for a new reservation.

### Receiving DNoP

A node that transmits a packet on a chunk and receives a DNOP unpins the chunk on which the DNOP was received, if it is not already unpinned. Note that if the node did NOT TRANSMIT any packet, but receives a DNoP, it DOES NOT unpin the chunk. To unpin a chunk, SPIN sets its isReserved to 0, and resets other fields as well.

If the DNOP is not received at some of the neighboring nodes, it may result in chunks for which there is no corresponding reserved chunk. Similarly, there may be resultant “orphaned” chunks, that is, chunks with a receive reservation for which there is no corresponding transmit reservation. Apart from temporarily occupying some resources unnecessarily this state is harmless and will expire eventually.

### Global Chunk Alignment

This procedure is invoked by the spin cycle updating procedure on the sender or receiver sides upon the successful receipt of a packet that cannot be Enclosed. Its purpose is to keep the chunks aligned across a connected component. The key idea is to impose an order on the nodes according to some criterion, and resolving conflicting alignments in favor of the packet (and accordingly the sender of the packet) whose source has a higher “status” in the order.

Misaligned chunks cause problems in various aspects of SPIN processing and cause fragmentation, both of which lead to reduced performance. A sender's chunk is misaligned at a receiver only if the sender's packet cannot be enclosed. However, it is possible that a packet is enclosable, yet the sender's chunk is misaligned in the sense that the difference in start slots is not an integral multiple of the SPIN-PERIOD. This situation is treated as aligned, and doing so, actually accommodate drifts within the reset period automatically. Misalignment across a pair of nodes A, B could be caused, for example, if the initial chunk in A was created independently of the initial chunk in B, i.e., based on unrelated packet events.

Each node maintains four state variables with respect to global alignment:
refMasterId: The source of the packet to which this node's spin cycle is aligned. Initialized to a number that is guaranteed to be larger than the largest node Id.
refSeqNum: The sequence number of the packet from the refMasterId based on which the entry was created. Used to break ties (see below). Initialized to NULL.
lastResetTime: The time at which the global alignment state (this 4-tuple) was last initialized. This is to support periodic resets to accommodate drift.

The procedure is as follows. First, the refMaster is checked. If the refMaster is the start value of larger than the largest node Id, it means that the alignment procedure has not been executed since (re-)initialization. In this case, the refMaster is made equal to the source of the received/sent packet (note: not the sender id, but the source id (from the transport header)), the refSeqNum is made equal to the sequence number of the received/sent packet (again from the transport header).

If the refMaster is not its initial value, then, given that the packet was non-enclosable, it means that the sender's chunk is misaligned with own, and corrective action is to be taken—basically, SPIN either rejects the new chunk or erases all of its chunks and starts afresh aligned to the new chunk. To do this, a lexicographic comparison of senderStatus=(received-pkt-source-id, received-pkt-seq-num) and myStatus=(refMasterId, refSeqNum) is made, which are stored as part of the node Global Align state. In a lexicographic comparison, a comparison by first element is made. If they are equal, then a second element comparison is made, and so on.
If myStatus is lexicographically greater than senderStatus, then the situation is deemed “myself dominant”. No action is taken.
If myStatus is lexicographically less than or equal to senderStatus, then the situation is deemed “sender dominant,” and the node deletes all of its chunks, both its own and neighbor-owned. It updates the Global Align state as follows: refMasterId=source-id of the packet; refSeqNum=sequence number of the packet.

At “steady state”, refMasterId need not necessarily be the highest ID in the network. For example, a lower ID node L starts a full flood and reaches all nodes before any other node originates a packet, then all refMasters will be L. Also, it is possible that adjacent nodes have different refMasters but are aligned.

If, after all nodes are aligned to a master node (e.g., M) which then disappears, then myStatus will always be greater than senderStatus and DNoPs will be sent upon detecting misalignment. This will prevent new misaligned reservations from being created, but existing ones would still drift apart. However, the Spin Cycle Reset described below will take care of this situation.

### Spin Cycle Reset

In order to address clock drifts and other unexpected events, every node deletes its Spin Cycle completely every GLOBALIGN_RESET_MINS minutes (anticipated to be approximately 10 minutes). This configuration parameter should be chosen such that the drift within this time is accommodated by the prefix/suffix slots.

### Long Packets

Thus far, all packets are assumed to fit within a chunk. However, it may be that there is a mix of packet sizes. While sizing the chunk to accommodate the largest-possible-sized packet is possible, this will result in considerable wastage of capacity when most packets are small. Therefore, SPIN has the ability to send a packet over multiple chunks.

Specifically, MAC frames in the current version consist of a control frame followed by 1-3 data frames. The chunk is currently sized so as to fit 1 control+1 data frame, which corresponds to a Position Location Information (PLI) payload—the most common application layer payload. In the case that the payload requires 2 or 3 data frames, SPIN uses an additional chunk. Two chunks may be sufficient for up to 3 data frames, which is the maximum allowable currently. For payloads that need more than two chunks, the packets may be sent using CSMA exclusively, with the reserve-request bit set to 0—that is, SPIN is not utilized for such packets, but is nonetheless supported.

### Spin Cycle Primitives

Although the implementation is free to choose any method that meets the foregoing specifications, there are several primitives that can make the management of the Spin Cycle reservations easier. The following primitives hide the details of the Spin Cycle, that is, the caller does not know about SPIN_PERIOD, for example. Basically, for simplicity they hide the details of the “modulo” arithmetic and allow the caller to utilize traditional arithmetic and assume real time in increments of one slot.
slots (T): Given a time interval T in the desired unit of measurement, get the equivalent in slots. Basically, this is T/ms per slot if the unit of measurement is milliseconds.
timeToSlot (t): Given a real clock time t, return the corresponding slot in the cycle based on the “initialization time” of the cycle (i.e., when the cycle slot time was zero). The formula is: (t-initializationTime) mod SPIN-PERIOD.
slotToTime(s, currentTime): Given a future slot and the current time, return the corresponding real-time in the future. Note that the current time is necessary because the slot is in a cycle.
slotAdd(s1, s2): Return the slot number that results from the addition of slot s1 and slot s2.
slotSubtract(s1, s2): Return the slot number that results when s2 is subtracted from s1.
between(s, s1, s2): Return True if slot s lies in between s1 and s2 (inclusive), False if not.
shift((startSlot, endSlot), value): Given a chunk (startSlot, endSlot), return the chunk that is shifted to the right (by positive value) or to the left (by negative value).
slotsMisaligned(s1, s2, tolerance): Return True if the slots are misaligned beyond tolerance, that is, slotSubtract (s1, s2) mod chunk-length>tolerance
enclosingChunkIndexOfSlot(start, [end]): Given a starting slot number, return the chunk index. This is straightforward and can be calculated using “integer division” as s/chunk-length. If an optional end slot is given then both start and end need to be in the same chunk to return a valid chunk. Returns NULL if no chunk can be found.

### Implementation Details

Most of the foregoing examples permit implementation of SPIN on any system. The following embodiment is directed to a specific goTenna firmware implementation.

Detecting Collisions and Overlap in a goTenna System

As noted above, a node can experience a Rcv-Rcv collision (the transmitting nodes are not neighbors); or an Xmt-Rcv collision (the transmitting nodes are neighbors). Each of these could be in the same or different channels.

### Rcv-Rcv Collision Detection

A collision (same channel) is deemed to happen if one of the following is true:
Energy is detected for a prespecified number of milliseconds but no preamble is detected (“Failed Energy Detect” (FED))
The data channel is tuned to, but no preamble is detected (“Timeout Preamble” (TiP))
The Sync Word Detection is timed out (SWD)
The CRC check fails.

To detect overlaps (different channels), assuming a 2-control channel system, an overlap channel selection is performed as follows:
after a control channel, SPIN checks the second channel if currently receiving on the first, otherwise, checks the first channel.
after a data channel, always check the first control channel.

Checking means that SPIN tunes to the selected channel and verify the energy after 2 ms.

If there is energy on either of the two cases, an recv-overlap is deemed to occur (OVL).

A Rcv-Rcv collision is detectable even if the packets line up exactly (due to #1 above) or randomly. A Rcv-Rcv overlap is detectable if the packets line up randomly but not perfectly.

### Xmt-Rcv Collision Detection

This is similar to the overlap detection. After transmitting on the control channel, a node listens on channel 0 for 3 ms before going back to transmitting on the data channel. If it hears energy, it assumes a collision or overlap. It is a collision if the original transmission was also on channel 0, and an overlap if not. Thus, the mechanism partially detects both collisions and overlaps. In particular, if the packets are exactly aligned (“on top of each other”), the collision is not detectable.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

By way of example and not of limitation, exemplary embodiments as disclosed herein may include but are not limited to:

### Embodiment 1

A method of using a slot pinning protocol in a wireless mesh network, comprising accessing a mesh network having a plurality of sender nodes in communication therewith; sensing a packet to be sent from one of the sender nodes in the mesh network; identifying a target channel in the mesh network for sending the packet therethrough; employing a hybrid access protocol to obtain transmission rights on the target channel; determining by the hybrid access protocol that transmission rights are immediately available on the target channel at a time t, or determining that transmission rights are not immediately available, acquiring rights to the channel at a future time t_{f}, and pinning the acquired channel thereafter at a future time t_{f}. transmitting the packet on the target channel at the time t, or at the future time t_{f} when the transmission rights become available on the pinned target channel.

### Embodiment 2

The method as in embodiment 1, wherein the mesh network includes low-capacity, mobile, or decentralized features.

### Embodiment 3

The method as in embodiments 1 or 2, wherein the plurality of sender nodes are in mutual communication to sense transmissions from each other on the target channel.

### Embodiment 4

The method as in any of the foregoing embodiments, wherein the plurality of sender nodes each employ an algorithm to delay sending a respective packet from a respective sender node to avoid a transmission conflict with another packet on the target channel.

### Embodiment 5

The method as in any of the foregoing embodiments, wherein the hybrid access protocol initially employs a contention-based access protocol to obtain the transmission rights then utilizes a contention-free access protocol.

### Embodiment 6

The method as in any of the foregoing embodiments, wherein the hybrid access protocol obtains the target channel at the time t_{f}.

### Embodiment 7

The method as in any of the foregoing embodiments, wherein exclusive rights to the target channel are obtained by the hybrid access protocol at time t+nP, wherein n is a positive integer and P is a configured SPIN_PERIOD, until revoked.

### Embodiment 8

The method as in any of the foregoing embodiments, wherein the hybrid access protocol supports broadcast and unicast conditions.

### Embodiment 9

The method as in any of the foregoing embodiments, wherein the hybrid access protocol is adaptable to fluctuating connectivity between at least two of the sender nodes.

### Embodiment 10

The method as in Embodiment 9, wherein the fluctuating connectivity results from at least one of a sender node mobility, RF propagation issues, or channel noise.

### Embodiment 11

The method as in any of the foregoing embodiments, further comprising a complex packet occupying a chunk of slots in a Spin Cycle.

### Embodiment 12

The method as in Embodiment 11, wherein real time corresponds to cycle time in the Spin Cycle.

### Embodiment 13

A slot pinning protocol in a wireless mesh network comprising a hybrid access protocol configured to acquire a transmission channel in a mesh network by contention to create a chunk reservation for transmitting a packet on the transmission channel at a predetermined future time; and a Do-Not-Pin feedback feature configured for recognizing and communicating faults to the hybrid access protocol; wherein the hybrid access protocol utilizes the Do-Not-Pin feedback mechanism and a jittered transmission to reduce conflicts on the transmission channel.

### Embodiment 14

The slot pinning protocol as in Embodiment 13, wherein the Do-Not-Pin feedback feature is configured to diagnose the faults as one of a collision of multiple packets on the transmission channel, a reservation violation, or an overlap in time at the receiver between two or more transmissions, each on a different channel in the mesh network.

### Embodiment 15

The slot pinning protocol as in Embodiment 14, wherein the jittered transmission employs a random offset at a beginning of the chunk.

### Embodiment 16

The slot pinning protocol as in Embodiments 14 or 15, wherein the packet fits into a single chunk on the transmission channel.

### Embodiment 17

The slot pinning protocol as in any of the Embodiments 14 through 16, wherein the hybrid access protocol is further configured to obtain or reserve at least two consecutive chunks to carry a packet larger than a single chunk.

### Embodiment 18

A method of aligning global chunks in a wireless mesh network using a slot pinning protocol comprising receiving a chunk from one of a plurality of nodes; and checking refMaster for a start value wherein if the start value is larger than a largest node Id of the plurality of nodes, the refMaster is equalized to a source of a received/sent packet.

### Embodiment 19

The method as in Embodiment 18, further comprising rejecting the chunk or erasing prior chunks and aligning to the received chunk if the refMaster is not at an initial desired value.

### Embodiment 20

The method as in Embodiments 18 or 19, further comprising lexicographically comparing a senderStatus=(received-pkt-source-id, received-pkt-seq-num) and myStatus=(refMasterId, refSeqNum).

### Embodiment 21

The method as in Embodiments 18, 19, or 20, wherein, if myStatus is lexicographically greater than the senderStatus, no action is taken.

### Embodiment 22

The method as in any one of Embodiments 18 through 21, wherein, if myStatus is lexicographically less than or equal to senderStatus, the largest node deletes its chunks.

That which is claimed is:

1. A method of using a slot pinning protocol in a wireless mesh network, comprising:
accessing a mesh network having a plurality of sender nodes in communication therewith;
sensing a packet to be sent from one of the sender nodes in the mesh network;
identifying a target channel in the mesh network for sending the packet therethrough;
employing a hybrid access protocol to obtain transmission rights on the target channel;
determining by the hybrid access protocol that transmission rights are immediately available on the target channel at a time t, or determining that transmission rights are not immediately available, acquiring rights to the channel at a future time tr, and pinning the acquired channel thereafter at a future time t_{f}.
transmitting the packet on the target channel at the time t, or at the future time t_{f} when the transmission rights become available on the pinned target channel.

2. The method as in claim 1, wherein the mesh network includes low-capacity, mobile, or decentralized features.

3. The method as in claim 1, wherein the plurality of sender nodes are in mutual communication to sense transmissions from each other on the target channel.

4. The method as in claim 1, wherein the plurality of sender nodes each employ an algorithm to delay sending a respective packet from a respective sender node to avoid a transmission conflict with another packet on the target channel.

5. The method as in claim 1, wherein the hybrid access protocol initially employs a contention-based access protocol to obtain the transmission rights then utilizes a contention-free access protocol.

6. The method as in claim 1, wherein the hybrid access protocol obtains the target channel at the time t_{f}.

7. The method as in claim 1, wherein exclusive rights to the target channel are obtained by the hybrid access protocol at time t+nP, wherein n is a positive integer and P is a configured SPIN_PERIOD, until revoked.

8. The method as in claim 1, wherein the hybrid access protocol supports broadcast and unicast conditions.

9. The method as in claim 1, wherein the hybrid access protocol is adaptable to fluctuating connectivity between at least two of the sender nodes.

10. The method as in claim 9, wherein the fluctuating connectivity results from at least one of a sender node mobility, RF propagation issues, or channel noise.

11. The method as in claim 1, further comprising a complex packet occupying a chunk of slots in a Spin Cycle.

12. The method as in claim 11, wherein real time corresponds to cycle time in the Spin Cycle.

13. A slot pinning protocol in a wireless mesh network, comprising:
a hybrid access protocol configured to acquire a transmission channel in a mesh network by contention to create a chunk reservation for transmitting a packet on the transmission channel at a predetermined future time; and
a Do-Not-Pin feedback feature configured for recognizing and communicating faults to the hybrid access protocol;
wherein the hybrid access protocol utilizes the Do-Not-Pin feedback mechanism and a jittered transmission to reduce conflicts on the transmission channel.

14. The slot pinning protocol as in claim 13, wherein the Do-Not-Pin feedback feature is configured to diagnose the faults as one of a collision of multiple packets on the transmission channel, a reservation violation, or an overlap in time at the receiver between two or more transmissions, each on a different channel in the mesh network.

15. The slot pinning protocol as in claim 13, wherein the jittered transmission employs a random offset at a beginning of the chunk.

16. The slot pinning protocol as in claim 13, wherein the packet fits into a single chunk on the transmission channel.

17. The slot pinning protocol as in claim 13, wherein the hybrid access protocol is further configured to obtain or reserve at least two consecutive chunks to carry a packet larger than a single chunk.

18. A method of aligning global chunks in a wireless mesh network using a slot pinning protocol, comprising:
receiving a chunk from one of a plurality of nodes; and
checking refMaster for a start value wherein if the start value is larger than a largest node Id of the plurality of nodes, the refMaster is equalized to a source of a received/sent packet.

19. The method as in claim 18, further comprising rejecting the chunk or erasing prior chunks and aligning to the received chunk if the refMaster is not at an initial desired value.

20. The method as in claim 19, further comprising lexicographically comparing a senderStatus=(received-pkt-source-id, received-pkt-seq-num) and myStatus=(refMasterId, refSeqNum).

21. The method as in claim 20, wherein, if myStatus is lexicographically greater than the senderStatus, no action is taken.

22. The method as in claim 20, wherein, if myStatus is lexicographically less than or equal to senderStatus, the largest node deletes its chunks.
